(19) United States
(12) Patent Application Publication
(10) Pub. No.: US 2003/0060105 A1
(43) Pub. Date: Mar. 27, 2003

(54) Cleaning wipe

(75) Inventors: John Puckhaber, Brick, NJ (US); Harry Aszman, Englishtown, NJ (US)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 09/920,673

(22) Filed: Aug. 2, 2001

(51) Int. Cl. B32B 27/04; B32B 3/00; B32B 5/02; D04H 13/00; B32B 27/12; B32B 9/00

(52) U.S. Cl. 442/123; 442/327; 442/96

(57) ABSTRACT

A cleaning wipe comprising a nonwoven fabric wherein the nonwoven fabric is impregnated with a cleaning composition.

### FIELD OF THE INVENTION

The present invention relates to a nonwoven fabric which has been impregnated with a liquid cleaning composition.

### BACKGROUND OF THE INVENTION

The patent literature describes numerous wipes for both body cleaning and cleaning of hard surfaces but none describe the instant cleaning wipes which have improved cleaning characteristics in the minimization of streaking and residue.

U.S. Pat. Nos. 5,756,612; 5,763,332; 5,908,707; 5,914,177; 5,980,922 and 6,168,852 teach cleaning compositions which are inverse emulsions.

U.S. Pat. Nos. 6,183,315 and 6,183,763 teach cleaning compositions containing a proton donating agent and having an acidic pH.

U.S. Pat. Nos. 5,863,663; 5,952,043; 6,063,746 and 6,121,165 teaches cleaning compositions which are oil in water emulsions.

### SUMMARY OF THE INVENTION

A cleaning wipe for cleaning hard surfaces such as keep counter tops, cabinets, furniture and floors comprises a nonwoven fabric containing at least polyester fibers and viscose fibers, wherein is the nonwoven fabric is impregnated with a liquid cleaning composition containing a metallic salt of a fatty acid, an alkali metal hydroxide, a hydroxy sultaine surfactant, a perfume, an amine oxide surfactant, and water, wherein the liquid cleaning composition is not an emulsion and does not contain proteins, enzymes, amides, sodium hypochlorite, dimethicone, a proton donating agent, N-methyl-2-pyrrolidone, monoalkyl phosphate or silicon based sulfosuccinate.

### DETAILED DESCRIPTION OF THE INVENTION

The present invention relates to a cleaning wipe for hard surfaces which comprises approximately:

(a) 20 wt. % to 40 wt. % of a nonwoven fabric which consists of at least polyester fibers and viscose fibers and preferably consists of 60 wt. % to 95 wt. % of wood pulp fibers, 2.5 wt. % to 20 wt. % of viscose fibers and 2.5 wt. % to 20 wt. % of polyester fibers; and

(b) 60 wt. % to 80 wt. % of a liquid cleaning composition being impregnated in said nonwoven fabric, wherein said liquid cleaning composition comprises:

(i) 0.5 to 35 wt. % of at least one alkaline metal salt of a fatty acid having about 8 to about 24 carbon atoms such as that in a tall oil fatty acid;

(ii) 0.1 to 2.5 wt. % of an alkali metal hydroxide;

(iii) 0.02 to 2.0 wt. % of a sultaine;

(iv) 0.02 to 2.0 wt. % of an amine oxide;

(v) 0.005 to 3 wt. % of a C₁-C₄ alkanol having about 1 to about 5 carbon atoms;

(vi) 0 to 0.4 wt. %, more preferably 0.01 wt. % to 0.25 wt. % of hydroxy ethylene diamine tetraacetic acid;

(vii) 0.01 wt. % to 1.5 wt. % of a perfume; and

(viii) the balance being water, wherein the composition has a pH of about 9 to about 13, at a concentration of about 10 grams of the composition in 100 ml. of water, a specific gravity at 20° C. of about 0.95 to 1.10 g/cm³.

The preferred long chain unsaturated fatty acids of the instant invention have about 8 to about 24 carbon atoms, more preferably about 10 to about 20 carbon atoms. A preferred unsaturated fatty acid mixture is a refined tall oil fatty acid. A typical tall oil fatty acid contains a mixture of a mono unsaturated C₁₆₋₁₈ fatty acid; a C₁₆₋₁₈ diene unsaturated fatty acid; a C₁₆₋₁₈ triene unsaturated fatty acid; and a C₁₆₋₁₈ saturated fatty acid. Other unsaturated fatty acids that are usable in the instant compositions are unsaturated vegetable oil fatty acids, including soy, peanut, corn, cottonseed, linseed and refined oleic fatty acids, and fatty acids consisting predominantly of C₁₈ (average) unsaturated fatty acids and mixtures thereof. The unsaturated fatty acid reacts in situ with the alkali metal hydroxide to form the alkali metal salt of the unsaturated fatty acid.

The composition contains about 0.02 to about 2.0 wt. % of an amine oxide, more preferably about 0.05 to about 1.5 wt. % and most preferably about 0.1 to about 1.0 wt. %. The preferred amine oxide is cocoamido-propylamine oxide. The amine oxide is depicted by the formula:

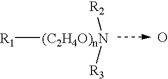

wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms; R₂ and R₃ are each methyl, ethyl, propyl, isopropyl, 2-hydroxyethyl, 2-hydroxypropyl, hydroxypropyl, or 3-hydroxypropyl; and n is from 0 to about 10. Particularly preferred are amine oxides of the formula:

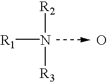

wherein R₁ is a C₁₂₋₁₈ alkyl and R₂ and R₃ are methyl or ethyl. The above ethylene oxide condensates, amides, and amine oxides are more fully described in U.S. Pat. No. 4,316,824 (Pancheri), incorporated herein by reference. An especially preferred amine oxide is depicted by the formula:

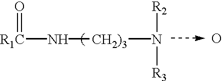

wherein R₁ is a saturated or unsaturated alkyl group having about 6 to about 24 carbon atoms, R₂ is a methyl group, and R₃ is a methyl or ethyl group. The preferred amine oxide is cocoamidopropyl-dimethylamine oxide.

The composition also contains about 0.02 to about 2.0 wt. %, more preferably about 0.05 to about 1.5 wt. % and most preferably about 0.1 to about 1.0 wt. % of a sultaine which is preferably a cocoamido-propylhydroxy sultaine. The sultaine can be depicted by the formula:

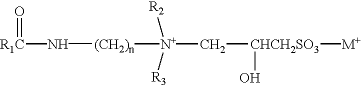

wherein R₁ is a saturated or unsaturated alkyl group having about 6 to about 24 carbon atoms, R₂ is a methyl or ethyl group, R₃ is a methyl or ethyl group, n is about 1 to about 6, and M⁺ is an alkali metal cation. The most preferred hydroxysultaine is a potassium salt of cocoamidopropyl hydroxysultaine.

The combination of the amine oxide and the sultaine functions to serve as a viscosity control agent while functioning as a means for the dispersion of lime soap.

The composition also preferably contains about 0.01 to about 1.5 wt. % of a perfume, more preferably about 0.1 to about 1.0 wt. %.

As used herein and in the appended claims the term “perfume” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced substance) odoriferous substances. Typically, perfumes are complex mixtures of blends of various organic compounds such as alcohols, aldehydes, ethers, aromatic compounds and varying amounts of essential oils (e.g., terpenes) such as from 0% to 80%, usually from 10% to 70% by weight, the essential oils themselves being volatile odoriferous compounds and also serving to dissolve the other components of the perfume.

In the present invention the precise composition of the perfume is of no particular consequence to cleaning performance so long as it meets the criteria of water immiscibility and having a pleasing odor. Naturally, of course, especially for cleaning compositions intended for use in the home, the perfume, as well as all other ingredients, should be cosmetically acceptable, i.e., non-toxic, hypoallergenic, etc.. The instant compositions show a marked improvement in ecotoxocity as compared to existing commercial products.

The cleaning composition of this invention may, if desired, also contain other components either to provide additional effect or to make the product more attractive to the consumer. The following are mentioned by way of example: Colors or dyes in amounts up to 0.5% by weight; preservatives or antioxidizing agents, such as formalin, 5-bromo-5-nitro-dioxan-1,3; 5-chloro-2-methyl-4-isothal iazolin-3-one, 2,6-di-tert.butyl-p-cresol, etc., in amounts up to 2% by weight; and pH adjusting agents, such as sulfuric acid or sodium hydroxide, as needed.

The cleaning compositions are prepared by simple batch mixing at 25° C.-30° C. The nonwoven fabric is impregnated with the liquid wood cleaning composition by means of a positive impregnation process. The liquid is positively fed into the nonwoven fabric through a controlled gear pump and injection bar at a ratio of about 2 grams of liquid glass cleaning composition to about 1 gram of the nonwoven fabric.

The nonwoven fabric is formed from 10 wt. % to 90 wt. % of viscose fibers and 10 wt. % to 90 wt. % of polyester fibers such as Spunlace made by the Dexter Corporation or Hydraspun (Dexter). More preferably the nonwoven fabric comprises 10 wt. % to 95 wt. % of wood pulp fibers, 1 wt. % to 40 wt. % of viscose fibers and 1 wt. % to 40 wt. % of polyester fibers. Such a nonwoven fabric which is manufactured by Dexter Corporation under the name Hydrapun comprises about 60% to 95% of wood pulp fabrics, 2.5 wt. % to 20 wt. % of viscose fibers and 2.5 wt. % to 20 wt. % of polyester fibers.

The following examples illustrate liquid cleaning compositions of the described invention. Unless otherwise specified, all percentages are by weight. The exemplified compositions are illustrative only and do not limit the scope of the invention. Unless otherwise specified, the proportions in the examples and elsewhere in the specification are by weight.

### EXAMPLE 1

The following compositions (in wt. %) were prepared by first dissolving the caustic material in the water and them adding the tall oil fatty acid. The balance of the ingredients are added in the order listed with mixing to the aqueous solution of the metal neutralized tall oil fatty acid. The cleaning wipe was made by the previously described impregnation process.

| | A |
|---|---|
| Part I | |
| Tall oil fatty acid | 16.18 |
| KOH 45% | 6.90 |
| Cocoamidopropylamine oxide | 1.64 |
| Cocoamidopropylhydroxy sultaine | 1.30 |
| Hydroxy EDTA 45% solution | 0.25 |
| Perfume | 0.58 |
| Water | Bal |
| pH 10% solution | 12.00 |
| Part I | 74.0 |
| Hydraspun | 26.0 |

While particular embodiments of the invention and the best mode contemplated by the inventors for carrying out the invention have been shown, it will be understood, of course, that the invention is not limited thereto since modifications may be made by those skilled in the art, particularly in light of the foregoing teachings. It is, therefore, contemplated by the appended claims to cover any such modifications as incorporate those features which constitute the essential features of these improvements within the true spirit and scope of the invention.

What is claimed:

1. A cleaning wipe which comprises approximately:
(a) 20 wt. % to 40 wt. % of a nonwoven fabric; and
(b) 60 wt. % to 80 wt. % of a liquid cleaning composition being impregnated in said nonwoven fabric, wherein said liquid cleaning composition comprises:
(i) 0.5 to 35% of at least one unsaturated fatty acid having about 8 to 24 carbon atoms;
(ii) 0.1 to 2.5% of an alkali metal hydroxide;
(iii) 0.02 to 2.0% of an amine oxide;
(iv) 0.02 to 2.0% of a sultaine; and
(v) the balance being water.

2. The wipe according to claim 1, further including a C₁-C₄ alkanol.

3. The wipe according to claim 1, wherein said metal hydroxide is potassium hydroxide.

4. The wipe according to claim 3, wherein said amine oxide is characterized by the formula: 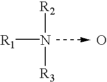
wherein R₁ is a C₁₂₋₁₆ alkyl and R₂ and R₃ are selected from the group consisting of methyl, ethyl, propyl, isopropyl, 2-hydroxethyl, 2-hydroxypropyl and 3-hydroxypropyl.

5. The wipe according to claim 4, wherein said amine oxide is cocoamido-propylamine oxide.

6. The wipe according to claim 1, wherein said sultaine is characterized by the formula: 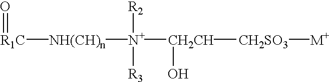
wherein n is about 1 to about 5, M⁺ is an alkali metal cation, R₂ is a methyl or ethyl group, R₃ is a methyl or ethyl group, and R₁ is a saturated or unsaturated alkyl group having about 6 to about 24 carbon atoms.

7. The wipe according to claim 6, wherein said sultaine is cocoamido-propylhydroxy sultaine.

8. The wipe according to claim 5, wherein said unsaturated fatty acid is a tall oil fatty acid.

9. The wipe according to claim 7, wherein said unsaturated fatty acid is a tall oil fatty acid.

10. The wipe according to claim 1, further including about 0.01 to about 1.5 wt % of a perfume.
